(19) United States
(12) Patent Application Publication
(10) Pub. No.: US 2012/0046962 A1
(43) Pub. Date: Feb. 23, 2012

(54) SYSTEM AND METHOD FOR GLUCOSE MONITORING AND ANALYSIS

(76) Inventor: James Andrew Fant, Woodstock, GA (US)

(21) Appl. No.: 13/212,239

(22) Filed: Aug. 18, 2011

Related U.S. Application Data
(60) Provisional application No. 61/375,420, filed on Aug. 20, 2010.

(51) Int. Cl. G06Q 50/00; G06Q 40/00; G06F 19/10

(52) U.S. Cl. 705/2; 702/21

(57) ABSTRACT

Methods, systems, and computer program products for analyzing glucose levels are disclosed. In an aspect, a method for analyzing glucose levels includes receiving a plurality of glucose levels, selecting a subset of glucose levels from among the plurality of received glucose levels that is associated with at least a first healthcare unit of a first healthcare provider, and analyzing the selected subset of glucose levels.

### CROSS REFERENCE TO RELATED PATENT APPLICATION

This application claims the benefit of U.S. Provisional Application No. 61/375,420 filed Aug. 20, 2010, hereby incorporated herein by reference in its entirety.

### BACKGROUND

In recent years it has become known that controlling the glucose levels of patients in hospitals results in reduced morbidity and mortality rates. For many years healthcare practitioners have been more concerned about low glucose levels rather than high glucose levels. A glucose level that is too low for a short period of time can result in death. Due to these concerns, a patient's glucose levels were maintained on the high side of normal or somewhat elevated. It was thought that these higher than normal levels were not hazardous to the patient during the short time the patient was in the hospital.

It has been discovered that high glucose levels can also be hazardous to the patient. High glucose levels can negatively affect the patient's immune system and limit the patient's ability to fight infections. It has also been discovered that better control of the patient's glucose levels also results in fewer low events. Accordingly, a number of national organizations including The Institute of Healthcare Improvement are recommending better management of glucose levels for patients.

To date, conventional glucose level collection has been largely manual, requiring a registered nurse (an expensive and limited resource) to review individual patient records. Accordingly, there is a need for analyzing glucose readings from a plurality of glucometers.

One of the chief obstacles to managing glucose readings has been the inability to monitor the success or failure of improvement initiatives, such as the introduction of protocols designed to better manage glucose levels. Thus, there is a need to analyze glucose measurements to identify patterns of performance relating to healthcare providers, healthcare provider units, personnel, personnel staffing schedules, time of day, and day of the week. There is also a need to incentivize glucose management by adjusting the amount of money paid to healthcare providers based on the glucose levels of their patients. Similarly, there is a need to addresses these and other deficiencies while allowing healthcare providers to continue using conventional glucometers.

### SUMMARY

The problems identified above can be addressed by the methods, systems, and computer program products (hereinafter “method” or “methods” for convenience) according to the present disclosure. As used herein and as understood by one of ordinary skill in the art, “healthcare provider” can comprise any entity, or any combination of entities, that directly or indirectly provides healthcare services, such as doctors, nurses, medical technicians, hospitals, laboratories, emergency medical services, clinics, imaging centers, therapy centers, chiropractic centers, ambulatory care centers, and the like.

Methods are described for analyzing glucose levels. In an aspect, provided are methods comprising, receiving, using a computer, a plurality of glucose levels; selecting, using the computer, a subset of glucose levels from among the plurality of received glucose levels that is associated with at least a first healthcare unit of a first healthcare provider; and analyzing, using the computer, the selected subset of glucose levels.

In another aspect, provided are methods comprising, receiving, using a computer, a plurality of glucose levels from at least a first healthcare provider; selecting, using the computer, a subset of glucose levels from among the plurality of glucose levels that is associated with at least a first healthcare unit of the first healthcare provider; comparing, using the computer, the selected subset of glucose levels to a reference; and adjusting, using the computer, an amount of insurance money to be paid for services that have or will be performed by the first healthcare provider based upon the comparison of the selected subset of glucose levels to the reference.

In a further aspect, provided are methods comprising, receiving, using a computer, a first plurality of glucose levels from at least a first healthcare provider at a first time; receiving, using the computer, a second plurality of glucose levels from at least the first healthcare provider at a second time; and comparing, using the computer, the received first plurality of glucose levels to the received second plurality of glucose levels to determine a difference in glucose levels.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows a logical overview of a computer system;

FIG. 2 illustrates an exemplary method for analyzing glucose levels.

FIG. 3 illustrates an exemplary method for analyzing glucose levels.

FIG. 4 illustrates an exemplary method for analyzing glucose levels.

FIG. 5 illustrates an exemplary feedback presented to a user;

FIG. 6 illustrates an exemplary feedback presented to a user;

FIG. 7 illustrates an exemplary feedback presented to a user;

FIG. 8 illustrates an exemplary feedback presented to a user;

FIG. 9 illustrates an exemplary feedback presented to a user;

FIG. 10 illustrates an exemplary feedback presented to a user;

FIG. 11 illustrates an exemplary feedback presented to a user;

FIG. 12 illustrates an exemplary feedback presented to a user;

FIG. 13 illustrates an exemplary feedback presented to a user;

FIG. 14 illustrates an exemplary feedback presented to a user;

FIG. 15 illustrates an exemplary feedback presented to a user; and

FIG. 16 illustrates an exemplary feedback presented to a user.

### DETAILED DESCRIPTION

Before the present methods and systems are disclosed and described, it is to be understood that the methods and systems are not limited to specific methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes [symbol] from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

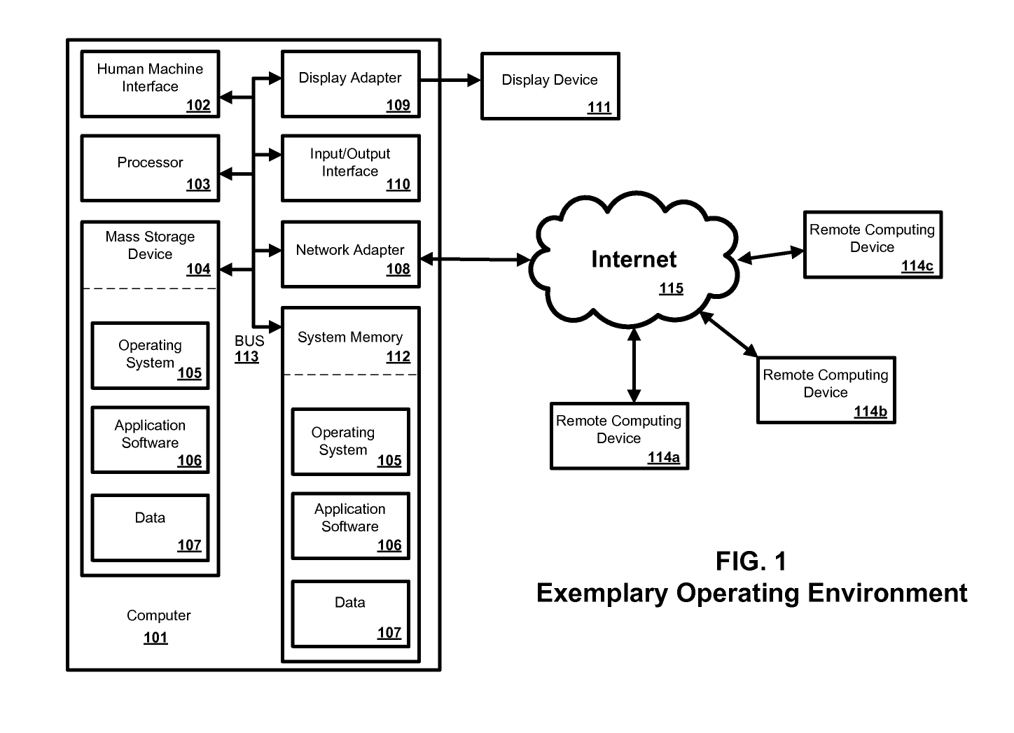

The present disclosure relates to systems and methods for monitoring and analyzing glucose levels. The methods disclosed herein can be carried out using a processor or processors. FIG. 1 is a block diagram illustrating an exemplary operating environment for performing the disclosed methods. The exemplary operating environment illustrated in FIG. 1 is an example of an operating environment and is not intended to suggest any limitation as to the scope of use or functionality of operating environment architectures. Neither should the operating environment be interpreted as having any dependency or requirement relating to any one or combination of components illustrated in the exemplary operating environment.

The methods of the present disclosure can be operational with numerous other general purpose or special purpose computing system environments or configurations. Examples of well known computing systems, environments, and/or configurations that may be suitable for use with the methods include, but are not limited to, personal computers, server computers, laptop devices, and multiprocessor systems. Additional examples include programmable consumer electronics, network PCs, minicomputers, mainframe computers, distributed computing environments that include any of the above systems or devices, and the like.

The methods may be described in the general context of computer instructions, such as program modules, being executed by a computer. Generally, program modules include routines, programs, objects, components, data structures, etc. that perform particular tasks or implement particular abstract data types. The methods may also be practiced in distributed computing environments where tasks are performed by remote processing devices that are linked through a communications network. In a distributed computing environment, program modules may be located in both local and remote computer storage media including memory storage devices.

The methods, systems, and computer program products disclosed herein can be implemented, in whole or in part, using a general-purpose computing device in the form of a computer 101. The components of the computer 101 can include, but are not limited to, one or more processors or processing units 103, a system memory 112, and a system bus 113 that couples various system components including the processor 103 to the system memory 112.

The processor 103 in FIG. 1 can be an x-86 compatible processor, including a PENTIUM, manufactured by Intel Corporation, a CORE, manufactured by Intel Corporation, or an ATHLON 64 processor, manufactured by Advanced Micro Devices Corporation, for example. Processors utilizing other instruction sets may also be used, including those manufactured by Apple, IBM, or NEC, for example.

The system bus 113 can represent one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 113, and all buses specified in this description can also be implemented over a wired or wireless network connection and each of the subsystems, including the processor 103, a mass storage device 104, an operating system 105, application software 106, data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The operating system 105 in FIG. 1 can comprise operating systems such as MICROSOFT WINDOWS operating systems, REDHAT LINUX, FREE BSD, or SUN MICROSYSTEMS SOLARIS. Additionally, the application software 106 may include web browsing software, such as MICROSOFT INTERNET EXPLORER or MOZILLA FIREFOX, enabling a user to view HTML, SGML, XML, or any other suitably constructed document language on the display device 111. Other operating systems and web browsing software can be used.

The computer 101 can comprise a variety of computer readable media. Such media can be any available media that can be accessible by the computer 101 and includes both volatile and non-volatile media, removable and non-removable media. The system memory 112 includes computer readable media in the form of volatile memory, such as random access memory (RAM), and/or non-volatile memory, such as read only memory (ROM). The system memory 112 can contain data such as data 107 and/or program modules such as operating system 105 and application software 106 that are immediately accessible to and/or are presently operated on by the processing unit 103.

The computer 101 can comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 104, including by way of example, an operating system 105 and application software 106. Each of the operating system 105 and application software 106 (or some combination thereof) may include elements of the programming and the application software 106. Data 107 can also be stored on the mass storage device 104. Data 104 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 101 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 103 via a human machine interface 102 that can be coupled to the system bus 113, but may be connected by other interface and bus structures, such as a parallel port, serial port, game port, or a universal serial bus (USB).

A display device 111 can also be connected to the system bus 113 via an interface, such as a display adapter 109. For example, a display device can be a cathode ray tube (CRT) monitor or a Liquid Crystal Display (LCD). Other display devices can be used. In addition to the display device 111, other output peripheral devices can include components such as speakers (not shown) and a printer (not shown) which can be connected to the computer 101 via Input/Output Interface 110.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are commonplace in offices, enterprise-wide computer networks, intranets, and the Internet/Web Server 115. In an aspect, an Internet/Web server can house the main ASP.Net application and can connect to a SQL Server 2005 database to compute the necessary calculations and perform the methods describe herein to the glucose data submitted by the healthcare provider and provide access to the contained graphs and charts.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of application software 106 may be stored on or transmitted across some form of computer readable media. An implementation of the disclosed method may also be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

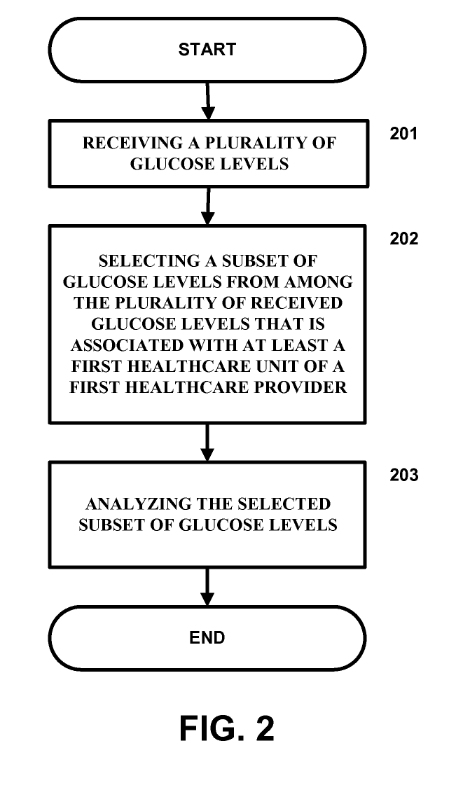

In an aspect, illustrated in FIG. 2, provided are methods for analyzing glucose levels. In step 201, a plurality of glucose levels can be received. In step 202, a subset of glucose levels can be selected from among the plurality of received glucose levels that can be associated with at least a first healthcare unit of a first healthcare provider. In step 203, the selected subset of glucose levels can be analyzed.

In an aspect, the step of receiving a plurality of glucose levels can comprise receiving a plurality of glucose levels from one or more glucometers. As an example, conventional glucometers can be used, such as the GLUCOMANDER. Further, the plurality of glucose levels can be received from one or more glucometers over at least a first network. In an aspect, the first network can comprise at least one of a wired or wireless network as understood by one of skill in the art.

Receiving a plurality of glucose levels can comprise receiving a plurality of glucose levels by the healthcare provider, such as by receiving a plurality of glucose levels at a computer operated by the healthcare provider. As an example, the computer can be the computer 101 shown in FIG. 1, or the like. Receiving a plurality of glucose levels can also comprise receiving a plurality of glucose levels over a network at a computer operated by the healthcare provider. The network can comprise one or more of a LAN, WAN, or the Internet. Further, the format of the plurality of glucose levels can be changed from a received format to a format for processing.

The first healthcare unit of the first healthcare provider can comprise any type of healthcare unit as understood by one of skill in the art, such as an intensive care unit, open heart unit, emergency care unit, surgical unit, and the like.

In an aspect, the step of analyzing the selected subset of glucose levels can comprise analyzing the selected subset of glucose levels by determining if one or more glucose levels in the selected subset of glucose levels are above a reference level. The levels above the reference level can be reported.

Analyzing the selected subset of glucose levels can also comprise analyzing the selected subset of glucose levels by determining an average glucose level for one or more glucose levels in the selected subset of glucose levels. Similarly, analyzing the selected subset of glucose levels can comprise analyzing the selected subset of glucose levels by determining if one or more glucose levels in the selected subset of glucose levels is below a reference level. For example, it can be determined if one or more glucose levels in the selected subset of glucose levels is above and/or below a reference level for a time period. Any time period can be used, such as minute, hour, day, week, month, year, or any combination thereof. The glucose level can be used to generate a feedback to a user such as one and/or more reports or files, for example.

In an aspect, analyzing the selected subset of glucose levels can comprise analyzing the selected subset of glucose levels by determining if one or more glucose levels in the selected subset of glucose levels is above a first reference level and/or below a second reference level, or by determining if one or more glucose levels in the selected subset of glucose levels is above a first reference level and/or below a second reference level for a time period. Any time period can be used, such as minute, hour, day, week, month, year, or any combination thereof.

In an aspect, the first reference level and/or the second reference level can be determined based on medicine and research parameters, physician and organizational preferences, routine or accepted practices, and/or patient variability. As an example, the reference level(s) can be based on a historical value comparison, comparison to others in similar or different demographic based on location, race, sex, age, body type, and the like. Other parameters can be used in determining the reference levels.

In an aspect, data obtained from the glucometers can be based on calibrations and programming associated with a particular patient, practitioner, or treatment facility. As an example, a glocometer can be calibrated to provide data including a patient identifier or account number, date and time of test, test result, unit identifier, and the like. As a further example, the particular information provided by the glocometer can be calibrated based upon specific data requirements and demographic interests of the user. It is understood that the glucometer can be configured to provide other data.

In an aspect, an indicator of a problem or no problem (disease state/no disease state) can be generated based upon the analysis of the glucose levels. As an example, the indicator can be visually presented to a user. As a further example, the indicator can be an alert such as a visual alert, audio alert, or an alert communicated to a user associated with the patient. Other indicators can be used.

In an aspect, a treatment for a patient can be adjusted based on the analysis of the glucose levels. As an example, protocols, physician orders, sliding scales or other forms of glucose treatment can be used to treat hypo- or hyper glycemia based on blood glucose analyses or feedback.

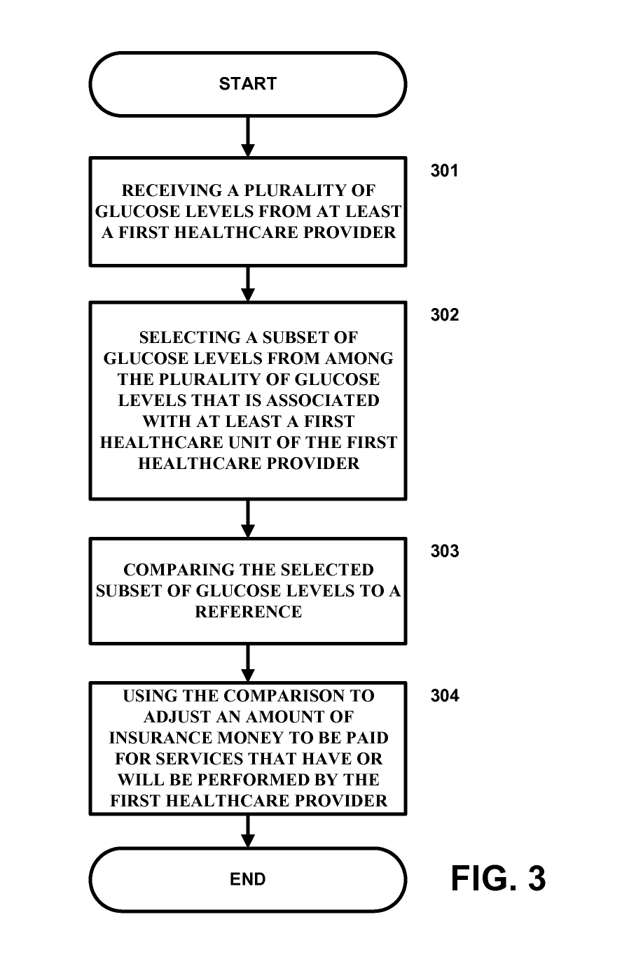

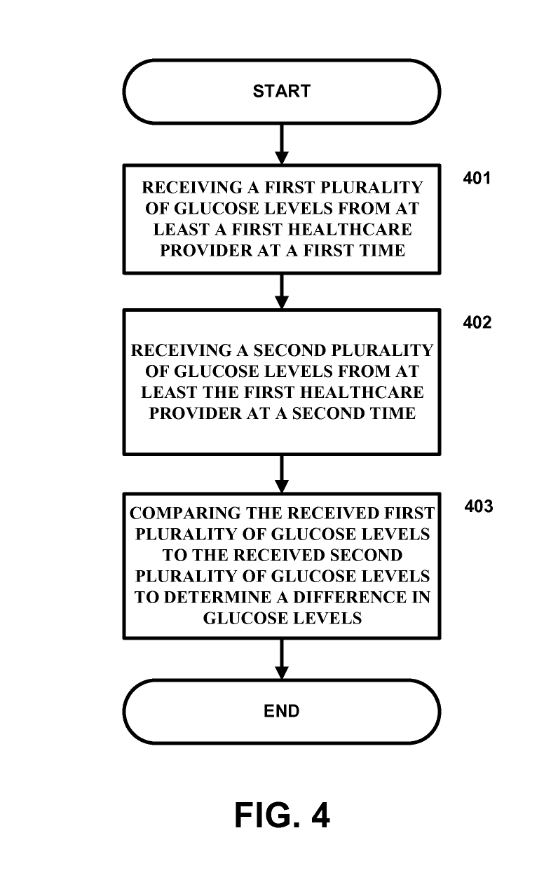

By way of example, the methods of FIG. 2 can comprise a computer program product encoded with computer-readable instructions for analyzing glucose levels by performing the steps of receiving a plurality of glucose levels, selecting a subset of glucose levels from among the plurality of received glucose levels that can be associated with at least a first healthcare unit of a first healthcare provider, and analyzing the selected subset of glucose levels. Similarly, the methods shown in FIG. 3 and FIG. 4, and any related embodiments and aspects, can be claimed as computer program products.

FIG. 3 illustrates an exemplary method for analyzing glucose levels. In step 301, a plurality of glucose levels can be received from at least a first healthcare provider. In step 302, a subset of glucose levels can selected 302 from among the plurality of glucose levels that can be associated with at least a first healthcare unit of the first healthcare provider. In step 303, the selected subset of glucose levels can be compared to a reference. In step 304, the comparison can be used to adjust an amount of insurance money to be paid for services that have or will be performed by the first healthcare provider.

In an aspect, the reference can be determined based on medicine and research parameters, physician and organizational preferences, routine or accepted practices, and/or patient variability. As an example, the reference can be based on a historical value comparison, comparison to others in similar or different demographic based on location, race, sex, age, body type, and the like. Other parameters can be used in determining the reference.

In an aspect, comparing the selected subset of glucose levels to a reference can comprise comparing the selected subset of glucose levels to a reference by determining if one or more glucose levels in the selected subset of glucose levels is one of above or below a reference level, such as above or below a reference level for a time period. Similarly, comparing the selected subset of glucose levels to a reference can comprise comparing the selected subset of glucose levels to a reference by determining if one or more glucose levels in the selected subset of glucose levels is above a first reference level and/or below a second reference level, such as by, for example, determining if one or more glucose levels in the selected subset of glucose levels is above a first reference level and/or below a second reference level for a time period. Comparing the selected subset of glucose levels to a reference can also comprise comparing the selected subset of glucose levels to a reference by generating a value from the selected subset of glucose levels and comparing the generated value to a reference. A reference can comprise at least one of a mean, median, mode, binary value, numerical value, textual value, score, or a set of one or more such references. A score can comprise at least one of a binary, numerical, or textual value.

In an aspect, the step of using the comparison to adjust an amount of insurance money can comprise using the selected subset of glucose levels to adjust an amount of insurance money to be paid for services that have or will be performed by the first healthcare provider. Using the comparison to adjust an amount of insurance money can also comprise using the selected subset of glucose levels to adjust an amount of insurance money to be paid for services that have or will be performed by the first healthcare unit of the first healthcare provider, and/or using the selected subset of glucose levels to adjust an amount of insurance money to be paid for services that have or will be performed by a second healthcare provider. Similarly, using the comparison to adjust an amount of insurance money can comprise using the selected subset of glucose levels to adjust an amount of insurance money to be paid for services that have or will be performed by a second unit of a second healthcare provider, wherein the first unit and the second unit provide substantially the same type of healthcare service.

In an aspect, the method of FIG. 3 can further comprise determining the reference using glucose levels received from a plurality of healthcare providers, or determining the reference using glucose levels previously received from at least the first healthcare provider. In an aspect, the method of FIG. 3 can further comprise using the comparison to adjust a glucose administration policy of one or more healthcare providers.

FIG. 4 illustrates an exemplary method for analyzing glucose levels. In step 401, a first plurality of glucose levels can be received from at least a first healthcare provider at a first time. In step 402, a second plurality of glucose levels can be received from at least the first healthcare provider at a second time. In step 403, the received first plurality of glucose levels can be compared to the received second plurality of glucose levels to determine a difference in glucose levels.

Receiving a plurality of glucose levels can comprise receiving a plurality of glucose levels from at least a first healthcare provider from one or more glucometers or receiving a plurality of glucose levels from at least a first healthcare provider from one or more glucometers over at least a first network.

Further, comparing the received first plurality of glucose levels to the received second plurality of glucose levels can comprise comparing the received first plurality of glucose levels to the received second plurality of glucose levels to determine a difference in glucose levels by comparing a first value generated from the received first plurality of glucose levels to a second value generated from the received second plurality of glucose levels.

The difference determined between the first and second plurality of glucose levels can be used to adjust an amount of insurance money to be paid for services that have or will be performed by at least the first healthcare provider, and/or the difference can be used to adjust an amount of insurance money to be paid for services that have or will be performed by at least a second healthcare provider. The difference can also be used to adjust at least one of a healthcare unit personnel or a healthcare unit personnel staffing schedule of one or more healthcare providers. The difference can also be used to generate a feedback such as one or more reports of files, for example.

In an aspect, an indicator of a problem or no problem (disease state/no disease state) can be generated based upon the analysis of the glucose levels. As an example, the indicator can be visually presented to a user. As a further example, the indicator can be an alert such as a visual alert, audio alert, or an alert communicated to a user associated with the patient. Other indicators can be used.

In an aspect, a treatment for a patient can be adjusted based on the analysis of the glucose levels. As an example, protocols, physician orders, sliding scales or other forms of glucose treatment can be used to treat hypo- or hyper glycemia based on blood glucose analyses or feedback.

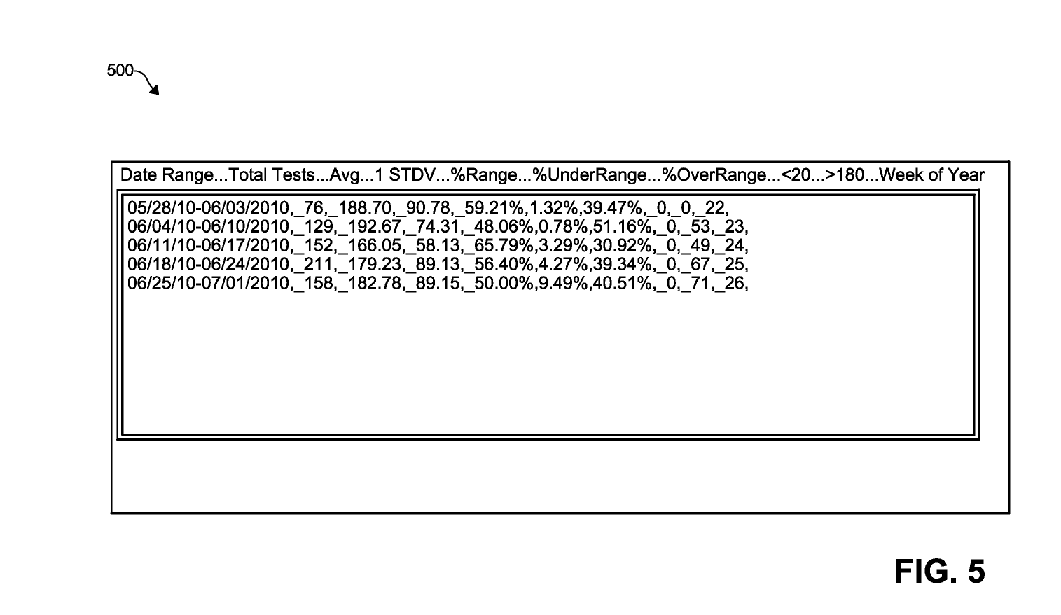

FIGS. 5-16 illustrate aspects of a software implementing the methods of the present disclosure. FIG. 5 illustrates an exemplary feedback 500 presented to a user. In an aspect, the feedback 500 is a visual feedback presented on a display. As an example, the feedback 500 can comprise a plurality of glucose readings records for a pre-determined time period. As an illustrative example, as shown in FIG. 5, the time period can be four weeks (from May 28, 2010 to Jul. 1, 2010) and the records can be associated with a particular healthcare provider. For each week, selected information fields can be presented to the user such as the total number of tests performed, the test average, the first standard deviation, the percent of glucose levels within the first standard deviation, as well as the number of glucose levels within certain ranges, for example.

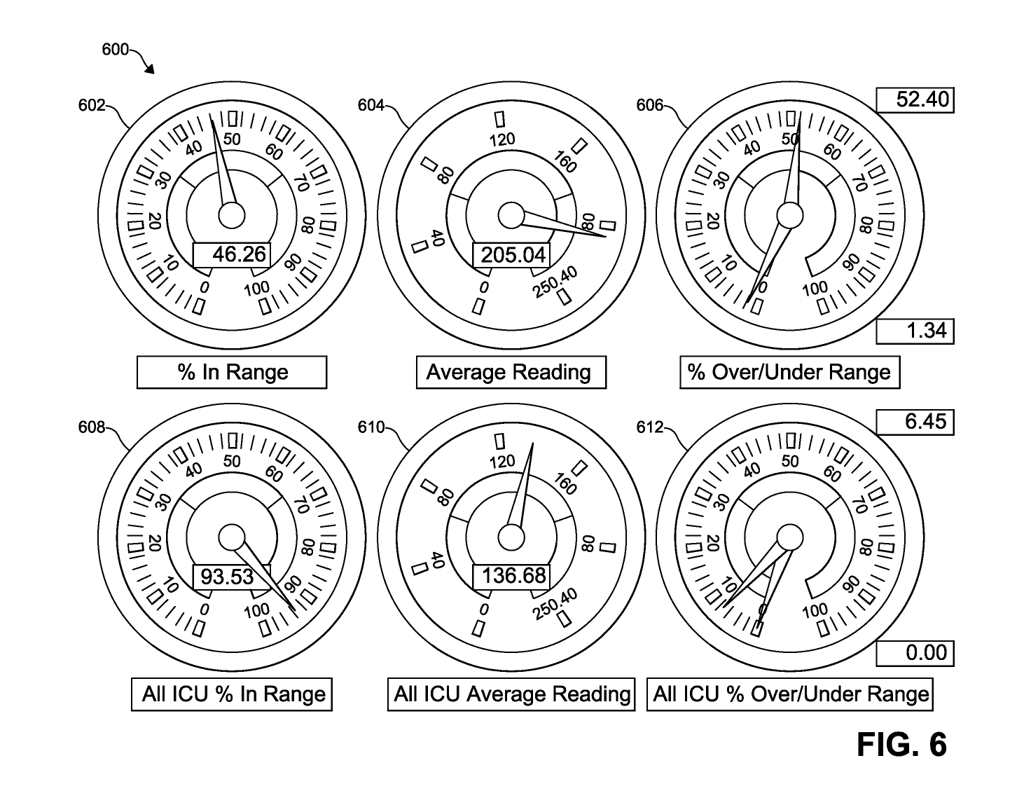

FIG. 6 illustrates an exemplary feedback 600 presented to a user. In an aspect, the feedback 600 is a visual feedback presented on a display. As an example, the feedback 600 can comprise a plurality of gauges 602, 604, 606, 608, 610, 612. As an illustrative example, as shown in FIG. 6, the gauges 602, 604, 606 can represent a percent of glucose readings within a pre-determined range, an average of the glucose readings received, a percent of the glucose readings over a pre-defined range, and a percent of the glucose readings under a pre-defined range.

In an aspect, the feedback 600 can be limited to a particular department, such as the intensive care unit (ICU). As an illustrative example, as shown in FIG. 6, the gauges 608, 610, 612 can represent a percent of glucose reading in an ICU within a pre-determined range, an average of the glucose readings received from an ICU, a percent of the glucose readings from an ICU over a pre-defined range, and a percent of the glucose readings from an ICU under a pre-defined range.

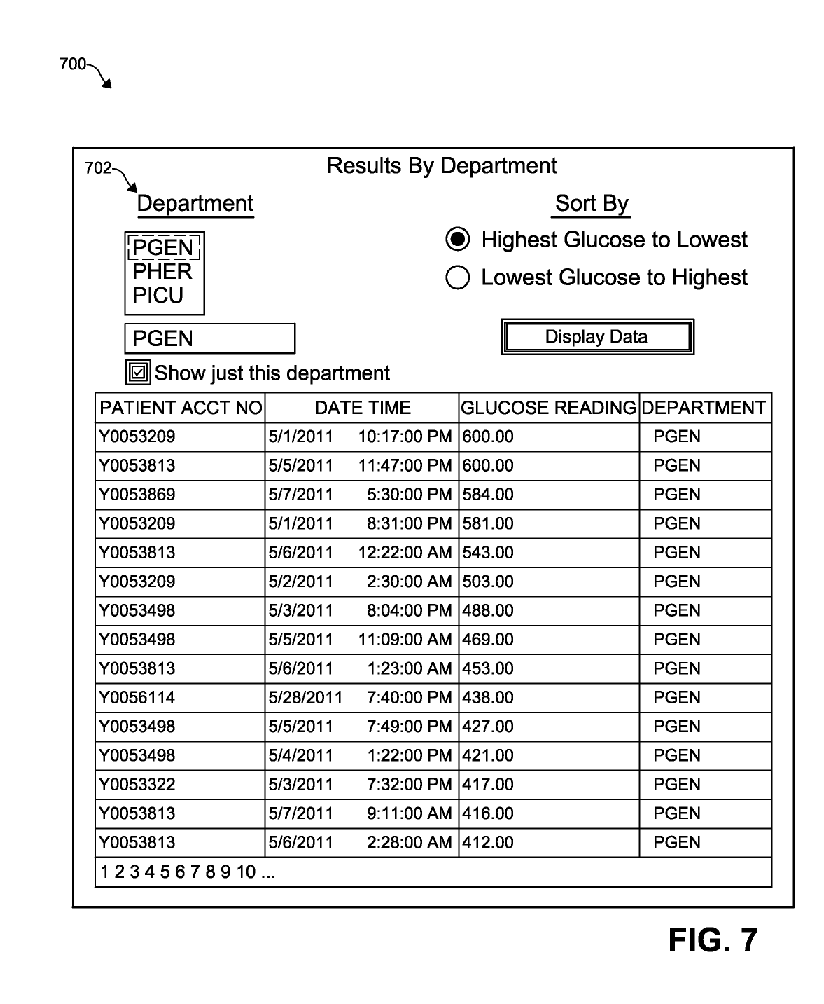

FIG. 7 illustrates an exemplary feedback 700 presented to a user. In an aspect, the feedback 700 is a visual feedback presented on a display. As an example, the feedback 700 can comprise a plurality of glucose readings records for a plurality of patients. As an example, each of the records can comprise fields such as patient account number, date and time, glucose measurement, and department from which the glucose measurements were received. In an aspect, the records can be presented for a select department in response to a user input 702.

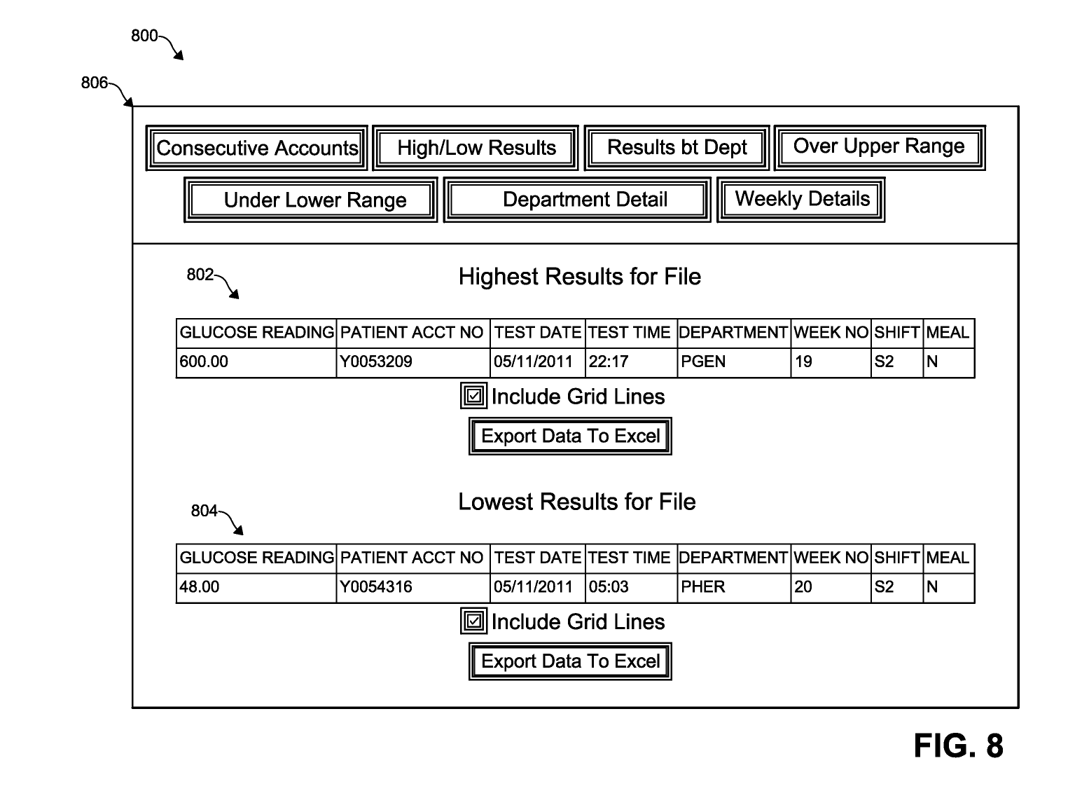

FIG. 8 illustrates an exemplary feedback 800 presented to a user. In an aspect, the feedback 800 is a visual feedback presented on a display. As an example, the feedback 800 can comprise weekly highest test results 802 for each week. As a further example, the feedback 800 can comprise weekly lowest test results 804. In an aspect, additional details relating to the glucose readings received can be displayed in response to a user selection of at least one of a plurality of buttons 806, or icons. As an example, the test results 802, 804 can be presented as graph. As a further example, the test results 802, 804 can be exported in various file formats, such as Microsoft Excel. Other formats can be used.

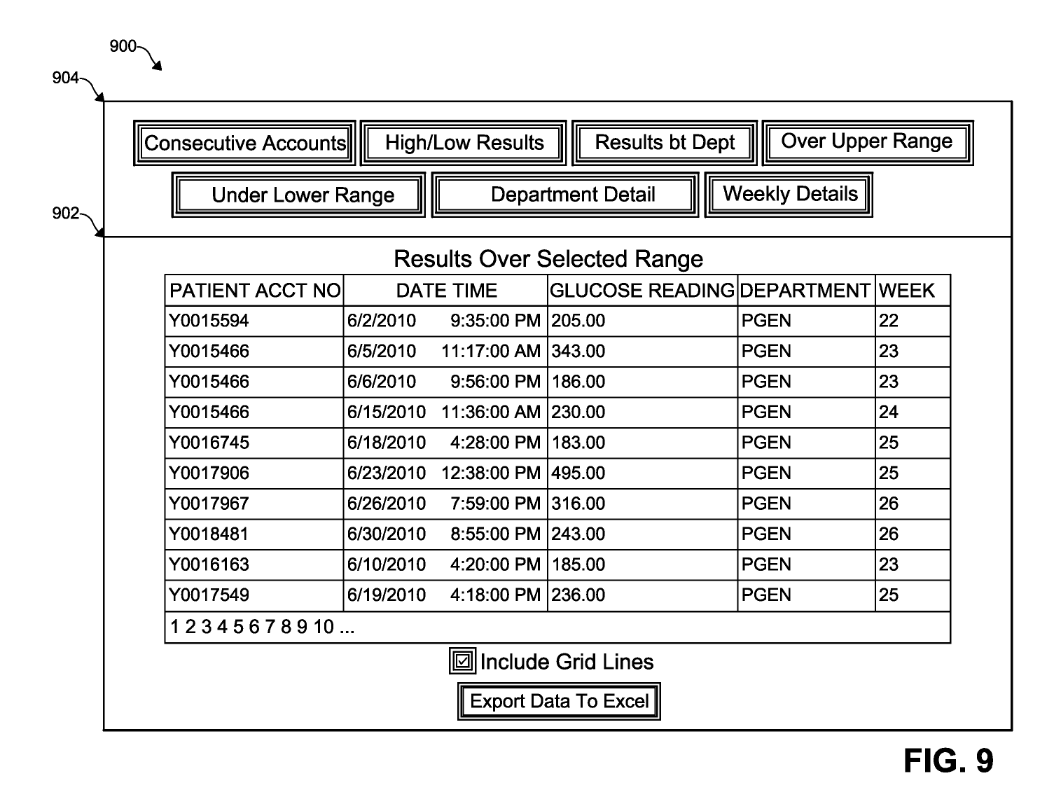

FIG. 9 illustrates an exemplary feedback 900 presented to a user. In an aspect, the feedback 900 is a visual feedback presented on a display. As an example, the feedback 900 can comprise a plurality of glucose readings records 902 that are over a pre-defined range or value, such as 180 mg/dL. Other ranges and values can be used. In an aspect, additional details relating to the glucose readings received can be displayed in response to a user selection of at least one of a plurality of buttons 904, or icons. As an example, the readings can be presented as a graph. As a further example, the readings can be exported in various file formats, such as Microsoft Excel. Other formats can be used.

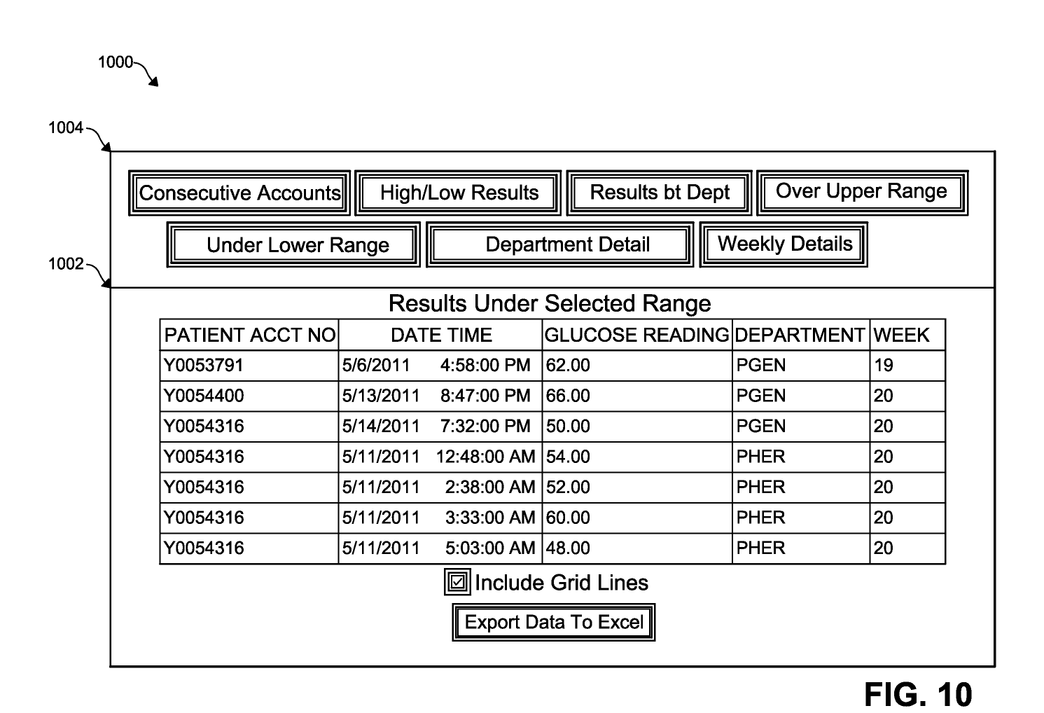

FIG. 10 illustrates an exemplary feedback 1000 presented to a user. In an aspect, the feedback 1000 is a visual feedback presented on a display. As an example, the feedback 1000 can comprise a plurality of glucose readings records 1002 that are under a pre-defined range or value, such as 80 mg/dL. Other ranges and values can be used. In an aspect, additional details relating to the glucose readings received can be displayed in response to a user selection of at least one of a plurality of buttons 1004, or icons. As an example, the readings can be presented as a graph. As a further example, the readings can be exported in various file formats, such as Microsoft Excel. Other formats can be used.

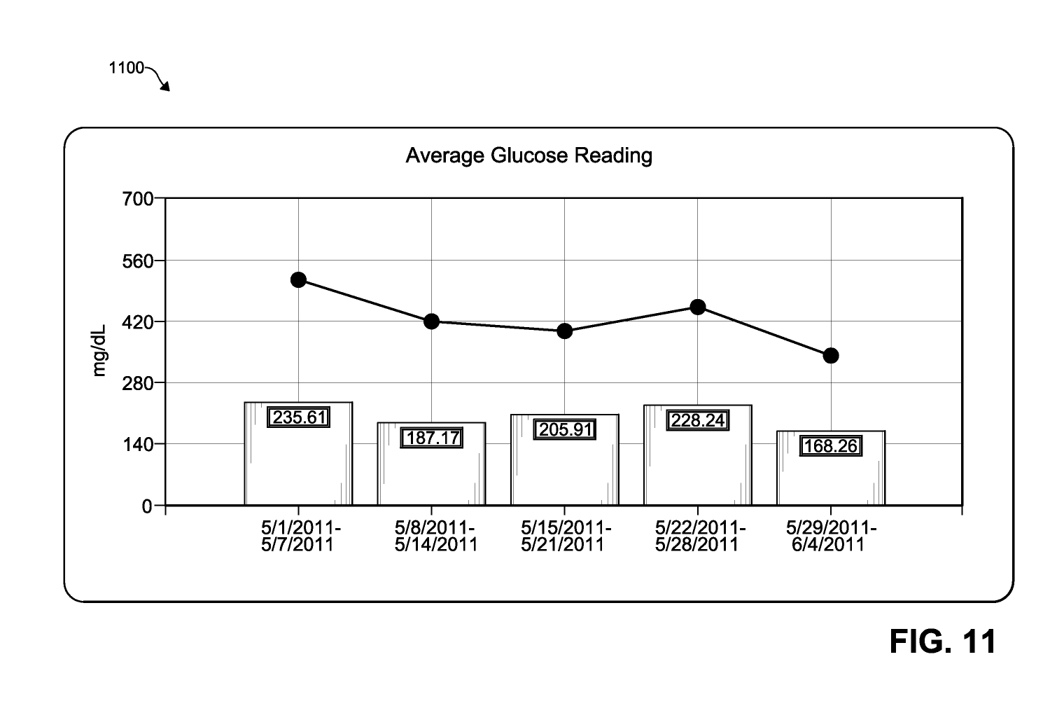

FIG. 11 illustrates an exemplary feedback 1100 presented to a user. In an aspect, the feedback 1100 is a visual feedback presented on a display. As an example, the feedback 1100 can comprise a graph of an average of a plurality of glucose readings for a plurality of pre-define time periods. It is understood that any time period can be defined.

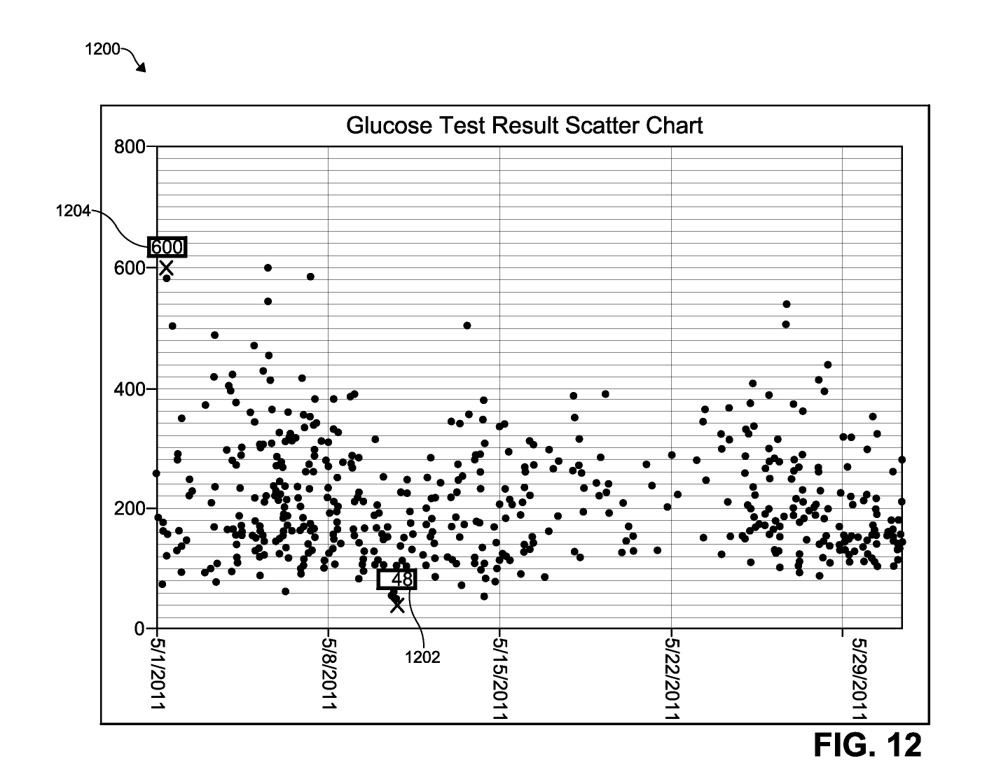

FIG. 12 illustrates an exemplary feedback 1200 presented to a user. In an aspect, the feedback 1200 is a visual feedback presented on a display. As an example, the feedback 1200 can comprise a scatter plot of a plurality of glucose readings for a plurality of pre-define time periods. It is understood that any time period can be defined. As an example, a minimum glucose reading 1202 and/or maximum glucose reading 1204 can be identified by the feedback 1200. Other information and details relating to the glucose readings can be displayed.

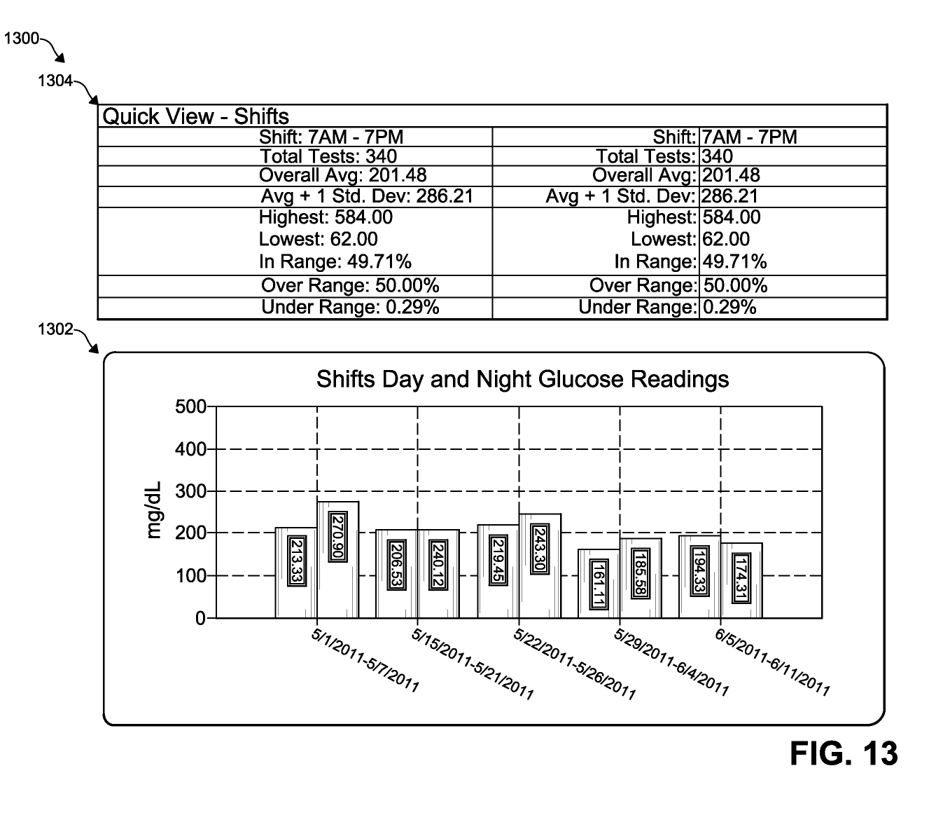

FIG. 13 illustrates an exemplary feedback 1300 presented to a user. In an aspect, the feedback 1300 is a visual feedback presented on a display. As an example, the feedback 1300 can comprise a graph 1302 of a plurality of glucose readings for a plurality of work shifts. As a further example, the feedback 1300 can comprise a quick view 1304 of information relating the glucose readings. Other information and details relating to the glucose readings can be displayed.

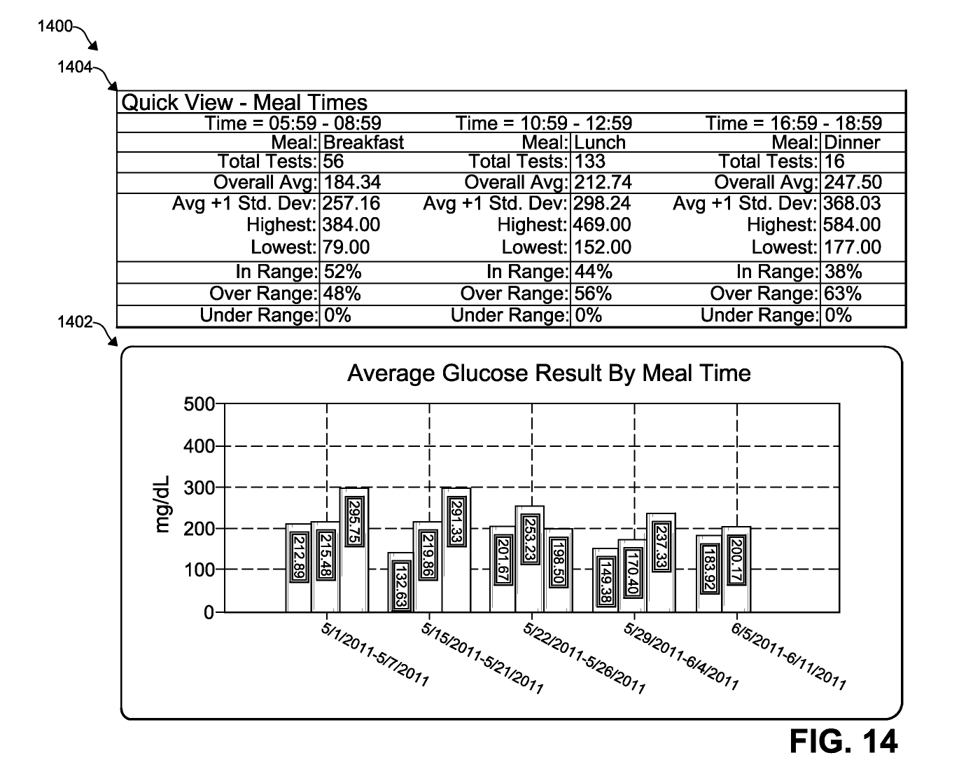

FIG. 14 illustrates an exemplary feedback 1400 presented to a user. In an aspect, the feedback 1400 is a visual feedback presented on a display. As an example, the feedback 1400 can comprise a graph 1402 of a plurality of glucose readings sorted by date and meal (e.g. breakfast, lunch, dinner, etc.) As a further example, the feedback 1400 can comprise a quick view table 1404 of information relating the glucose readings. Other information and details relating to the glucose readings can be displayed.

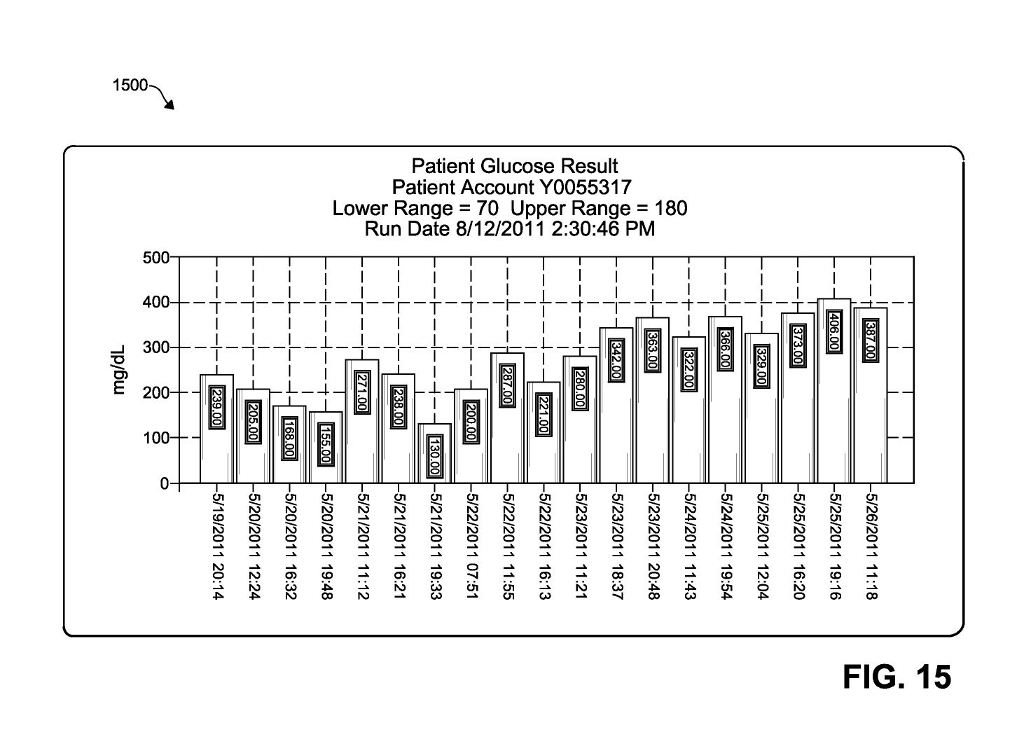

FIG. 15 illustrates an exemplary feedback 1500 presented to a user. In an aspect, the feedback 1500 is a visual feedback presented on a display. As an example, the feedback 1500 can comprise a graph of a plurality of glucose readings for a particular patient over a pre-defined time period. Other information and details relating to the glucose readings can be displayed.

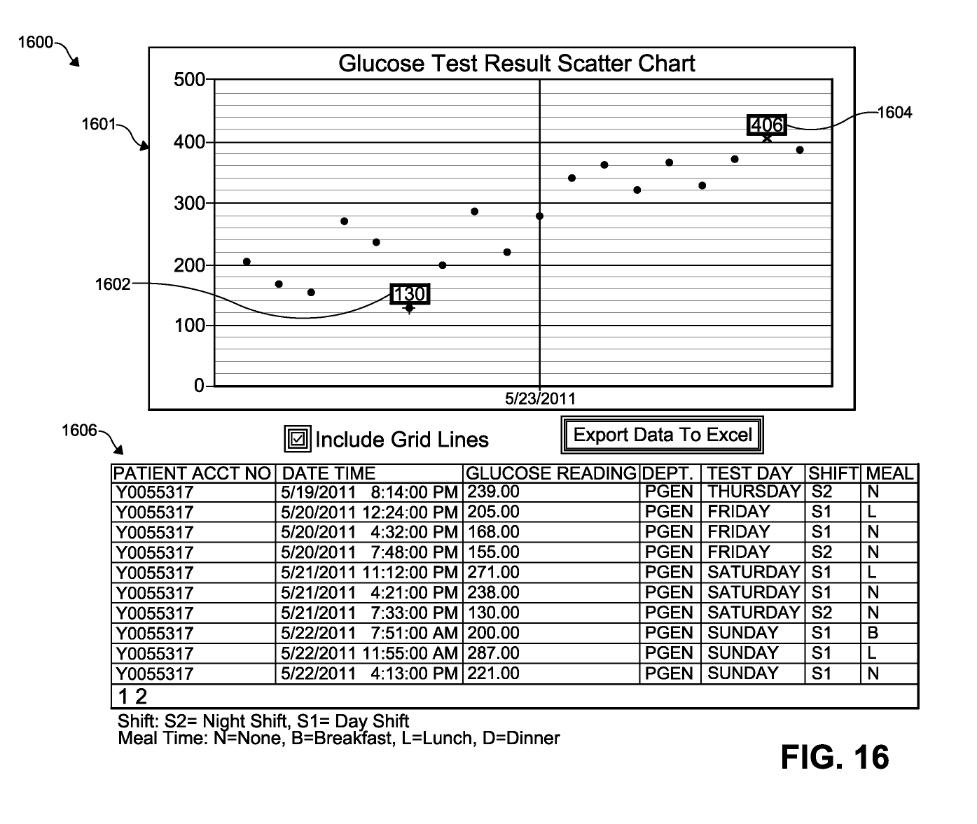

FIG. 16 illustrates an exemplary feedback 1600 presented to a user. In an aspect, the feedback 1600 is a visual feedback presented on a display. As an example, the feedback 1600 can comprise a scatter plot 1602 of a plurality of glucose readings for a particular patient. In an aspect, the feedback 1600 can include an identification of a minimum 1602 glucose reading and a maximum glucose reading 1604 for easy analysis by a user. As a further example, the feedback 1600 can comprise a quick view 1606 of information such as patient identifier, date, time, department, work shift, and meal at which the glucose reading was taken. Other information and details relating to the glucose readings can be displayed.

The systems and methods described herein can receive and process thousands of glucose reading in a time efficient manner. The glucose readings can be sorted and organized into a useful format to replace the tedious manual and error prone methods currently used. The methods described herein do not require any manual chart abstraction.

As an example, a hospital level analyzing can reveal the quality of glucose management. As a further example, a departmental analyzing compares unit performance. A patient level detail can trace patient's steps as they move through the system. The chronological data can reveal if there are opportunities in response time by the clinicians. The graphs generated reveal a quick snapshot of overall performance. Because all data generated can be exported into a spreadsheet format, the information can be linked to other databases that contain other patient history and outcomes. Because the data can be examined concurrently as well as retrospectively treatment can be altered quickly. The use of protocols can also be measured for effectiveness. The application can illustrate to physicians variations in practice patterns.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

We claim:

1. A method for analyzing glucose levels, comprising:
a. receiving, using a computer, a plurality of glucose levels;
b. selecting, using the computer, a subset of glucose levels from among the plurality of received glucose levels that is associated with at least a first healthcare unit of a first healthcare provider; and
c. analyzing, using the computer, the selected subset of glucose levels.

2. The method of claim 1, wherein receiving a plurality of glucose levels comprises receiving a plurality of glucose levels from one or more glucometers.

3. The method of claim 1, wherein receiving a plurality of glucose levels comprises receiving a plurality of glucose levels from one or more glucometers over at least a first network.

4. The method of claim 1, wherein the first healthcare unit of the first healthcare provider comprises at least one of an intensive care unit, open heart unit, surgical unit, or emergency care unit.

5. The method of claim 1, further comprising generating a feedback, using the computer, based upon the analyzed subset of glucose levels.

6. The method of claim 1, wherein analyzing the selected subset of glucose levels comprises determining if one or more glucose levels in the selected subset of glucose levels is above a reference level.

7. The method of claim 6, further comprising generating a feedback, using the computer, based upon the one or more glucose levels that are determined to be above the reference level.

8. The method of claim 1, wherein analyzing the selected subset of glucose levels comprises determining an average glucose level for one or more glucose levels in the selected subset of glucose levels.

9. The method of claim 1, wherein analyzing the selected subset of glucose levels comprises determining if one or more glucose levels in the selected subset of glucose levels is below a reference level.

10. The method of claim 1, wherein analyzing the selected subset of glucose levels comprises determining if one or more glucose levels in the selected subset of glucose levels is below a reference level for a time period.

11. The method of claim 10, further comprising generating a feedback, using the computer, based upon the one or more glucose levels that are determined to be below the reference level.

12. A method for analyzing glucose levels, comprising:
a. receiving, using a computer, a plurality of glucose levels from at least a first healthcare provider;
b. selecting, using the computer, a subset of glucose levels from among the plurality of glucose levels that is associated with at least a first healthcare unit of the first healthcare provider;
c. comparing, using the computer, the selected subset of glucose levels to a reference; and
d. adjusting, using the computer, an amount of insurance money to be paid for services that have or will be performed by the first healthcare provider based upon the comparison of the selected subset of glucose levels to the reference.

13. The method of claim 12, wherein comparing the selected subset of glucose levels to a reference comprises generating a value from the selected subset of glucose levels and comparing the generated value to a reference.

14. The method of claim 13, wherein the value comprises at least one of a mean, median, mode, and a score.

15. A method for analyzing glucose levels, comprising:
a. receiving, using a computer, a first plurality of glucose levels from at least a first healthcare provider at a first time;
b. receiving, using the computer, a second plurality of glucose levels from at least the first healthcare provider at a second time; and
c. comparing, using the computer, the received first plurality of glucose levels to the received second plurality of glucose levels to determine a difference in glucose levels.

16. The method of claim 15, wherein receiving a first plurality of glucose levels comprises receiving a first plurality of glucose levels from at least a first healthcare provider at a first time from one or more glucometers over at least a first network.

17. The method of claim 15, wherein comparing the received first plurality of glucose levels to the received second plurality of glucose levels comprises comparing the received first plurality of glucose levels to the received second plurality of glucose levels to determine a difference in glucose levels by comparing a first value generated from the received first plurality of glucose levels to a second value generated from the received second plurality of glucose levels.

18. The method of claim 17, wherein the first value and the second value each comprise at least one of a mean, median, mode, or a score.

19. The method of claim 15, further comprising adjusting an amount of insurance money to be paid for services that have or will be performed by the first healthcare provider based upon the comparison of the received first plurality of glucose levels to the received second plurality of glucose levels.

20. The method of claim 15, further comprising identify a pattern of performance for the first healthcare provider based up the comparison of the received first plurality of glucose levels to the received second plurality of glucose levels.
